(19) United States
(12) Patent Application Publication
(10) Pub. No.: US 2020/0283233 A1
(43) Pub. Date: Sep. 10, 2020

(54) FLEXIBLE CONVEYOR BELT ASSEMBLY WITH CHAIN TRACTION SYSTEM AND CAPACITY TO FOLLOW A CURVE

(71) Applicant: ANDRÉ RICARDO SALES SANTANA, BELO HORIZONTE - MG (BR)

(72) Inventor: ANDRÉ RICARDO SALES SANTANA, BELO HORIZONTE - MG (BR)

(21) Appl. No.: 16/649,823

(22) PCT Filed: Sep. 24, 2018
(86) PCT No.: PCT/BR2018/050351

§ 371 Date: Mar. 23, 2020

(30) Foreign Application Priority Data
Sep. 24, 2017 (BR) 10 2017 020393 0
Sep. 24, 2018 (BR) 10 2018 069464 2

(51) Int. Cl. B65G 17/12; B65G 17/38; B65G 17/42; B65G 21/18; B65G 21/22; B65G 17/36; B65G 23/44; B65G 23/06

(52) U.S. Cl. CPC B65G 17/12; B65G 17/385; B65G 17/42; B65G 21/18; B65G 2812/02069; B65G 17/36; B65G 23/44; B65G 23/06; B65G 21/22

(57) ABSTRACT

The present invention relates to a flexible conveyor belt assembly (100) with a chain traction system for moving products/raw materials in bulk, which comprises a support structure extending in a straight or curved manner (105), to which are fixed the rails (102), the toothed actuating wheel (103) and the toothed return wheel (106), which additionally comprises deflection wheels (109), a flexible conveyor belt (101), with a pleated profile, produced with metallic inserts (108), a chain (107) and pulleys (104) that move along the structure, in which traction is exerted on the chain (107).

### FIELD OF THE INVENTION

The present invention relates to a flexible conveyor belt assembly with chain traction system and capacity to follow curves suitable for the bulk transportation. In particular, the conveyor belt assembly is flexible, having the capacity to be curved both vertically and horizontally.

More particularly, the present invention relates to a rubber flexible conveyor belt assembly that, in addition to the capacity of following vertical curves, such as the belts already disclosed by the prior art, also have the capacity of following horizontal curves with short radii and at any angle.

### TECHNICAL BACKGROUND

As is already known from the prior art, conventional bulk conveyor belts (for example, ores, grains, sand) are mechanical devices that have the function of moving these materials through the displacement of a surface, which may be a belt of elastomeric material, for example, rubber, the surface of which is tensioned due to the rotation of two or more drums. This movement of the surface is only straight and/or may have a vertical component in order to raise the material to be transported.

Conveyor belts generally consist basically of a metallic structure that includes the support of a belt that slides on rollers, a drive drum coupled to a gearmotor, a return drum and a rubber belt.

It can be considered that the conventional bulk conveyor belts only operate in two dimensions, that is, in forward/backward and vertical movement, not being possible to follow horizontal curves at great angles (for example 45°, 60° and 90°) and with a short radius (for example, 3 to 5 meters).

Existing belts are capable of following only smooth curves and for horizontal curves at wide angles to be made, the radius would need to be very long, for example, in the range of 300 to 500 meters. Due to this limitation, whenever it is necessary to make changes in the path of the conveyed material, it is necessary to use two or more interconnected conveyor belts, which requires more electric motors, drives, thus, significantly increasing the consumption of electrical energy.

Brazilian patent application No. BR 10 2015 031912 6, filed on Dec. 19, 2015, in the name of ANDRÉ RICARDO SALES SANTANA, and entitled: “CORREIA TRANSPORTADORA”, describes a flexible conveyor belt that has the capacity of following horizontal curves with short radii and at great angles suitable for the movement of bulk products such as ores, grains, sand, etc. However, as can be seen from FIG. 1 of this document, the traction is exerted on the rubber belt, as it is done in the present invention. Furthermore, the rubber belt is solid, and the drive is carried out through a toothed drum, with the movement being carried out through independent pulleys not connected in pairs, as can be seen from FIGS. 3 and 4, respectively. FIGS. 5, 6 and 7 of this document also show that the pulleys are fixed directly on the rubber belt and that the efforts in the horizontal curves are supported only through the double rails, and it does not has the deviation wheels, according to the present invention.

Australian patent application No. AU 2012250485, filed on Apr. 30, 2012, in the name of LANGKILDE ENGINEERING SERVICES, and entitled: “A CONVEYOR SYSTEM” discloses an actionable mobile transport system for transporting a material, such as ore iron or overload. The conveyor system provides: (a) a conveyor belt for transporting material from a loading location to a unloading location; (b) a support structure comprising at least one support module for supporting the belt so that the belt system is flexible over at least a portion of the conveyor system; (c) a driver connected to the support structure to drive the belt system in a controlled mode in either forward, backward and lateral direction; and (d) a controller to control the driver.

However, the conveyor system of document AU 2012250485 is initially arranged in a curve arrangement with one or more curves to accommodate the initial proximity of loading and unloading locations and becomes more linear as it moves away from the same (page 3, lines 18 to 22). In addition, the flexibility of the belt system and the controller in the actionable belt system makes it possible to move the belt system in a controlled manner. The support structure can comprise a plurality of support modules coupled together along the length of the belt (page 5, lines 1 to 2), wherein each support module can comprise a segmented bar comprising a plurality of column segments which are coupled together. The column segments of each support module can be coupled together to allow the segments to rotate in relation to each other in a generally horizontal plane (page 6, lines 25 to 32). Each column segment can comprise a belt support structure for pulley mountings to support the conveyor belt and the drive modules drive the belt (page 11, line 30).

Although document AU 2012250485 has a conveyor belt in modules that is capable of following curves and has a support structure on pulleys, the actuation is done on the belt and not on the chain. In addition, this document does not inform the type of actuation performed.

U.S. Pat. No. 3,701,411, granted on Oct. 31, 1972, in the name of THE BF GOODRICH COMPANY, and entitled: “CONVEYOR SYSTEM” discloses a mobile conveyor system to transport bulk material both in a straight and transversally curved route, having an endless (flexible) elastomeric belt formed with a central spine and the edges on each side wavy to allow the transverse flexion. The power means are provided on the tractor means to continuously drive the belt over the drums. A plurality of portable belt support means in the form of trolleys is provided, wherein each trolley has a single pair of transversely spaced support wheels mounted so as to rotate on a centrally located axis in a transversely spaced arrangement. The belt is supported on a plurality of pulleys. The actuation is carried out at the discharge end of said belt.

Although document U.S. Pat. No. 3,701,411 describes a flexible conveyor belt system, the effort of which is supported by means of diverter wheels, the drive is carried out on the belt and on the drums.

U.S. Pat. No. 4,850,475, granted on Jul. 25, 1989, in the name of JOSEPH LUPO, and entitled: “CURVED PATH CHAIN LINK CONVEYOR MODULES AND BELTS” discloses a transport system with an endless chain mounted and coiled on a structure. This chain has a plurality of connected pins. A actuator motor is coupled to the chain to circulate it around the structure. The system has an endless belt coiled around the frame to support the ends along a predetermined length of the chain centrally on the pins. Thus, the circulation of the chain causes the circulation of the belt.

U.S. Pat. No. 4,850,475 discloses a conveyor system in which actuating means are provided for the circular current around said structure means. In addition, drive means are provided for the conveyor belt to cause tension on it. The belt is composed of a plurality of loosely spaced pulleys coupled at each end by connections.

As can be seen, none of the prior art documents describes or suggests a flexible conveyor belt assembly capable of following curves with short radii and at large angles, wherein the traction is exerted on the chain, such as the present invention.

### SUMMARY OF THE INVENTION

To solve the aforementioned problem, the present application will provide significant advantages in relation to the existing belt and/or belts assemblies, making it possible to perform the same work of two or more conventional interconnected conveyor belts, wherein the necessary traction to move the material transported is made in a single chain attached to the belt, therefore, the belt itself does not suffer traction efforts, not being stretched. The chain is designed so that it can suffer small deflections (degrees) between each link, thus, making it possible to follow horizontal curves.

Although the flexible conveyor belt assembly of the present invention has as a differential the capacity of following curves with short radii and at large angles, it can also be designed to be straight only.

### BRIEF DESCRIPTION OF THE DRAWINGS

For a detailed description of the invention, below, reference will be made to the attached drawings, in which:

FIG. 1 shows the perspective view of the flexible conveyor belt assembly with the subassemblies highlighted.

FIG. 2 shows the enlarged perspective view to show details of the equipment's actuating wheel (hidden gearmotor).

FIGS. 3a and 3b show the enlarged/front perspective view of the wheel and the double return rails.

FIG. 4 shows the complete side view of part of the flexible conveyor belt assembly showing the rubber belt, chain, rails, return wheel and other components.

FIGS. 5a and 5b show views of the curved part of the equipment showing the rubber modules and the arrangement of the horizontal support wheels.

FIGS. 6a-6d show the view of some highlighted subassemblies in more detail.

FIGS. 7a-7c show views of the overlapping belt modules highlighting the metallic inserts of the belt and the pulleys.

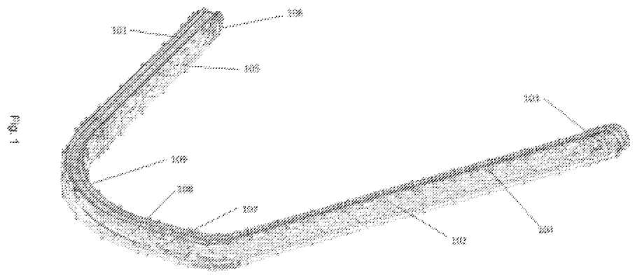

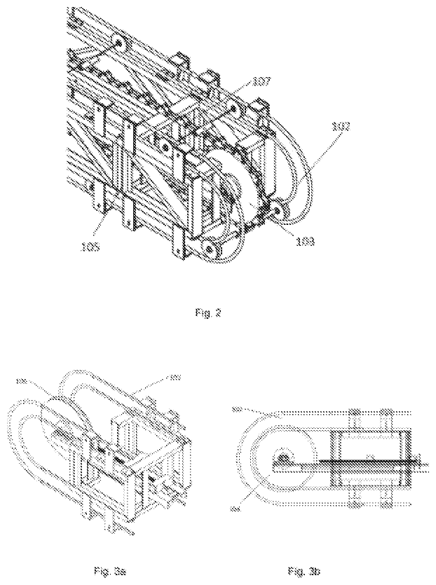

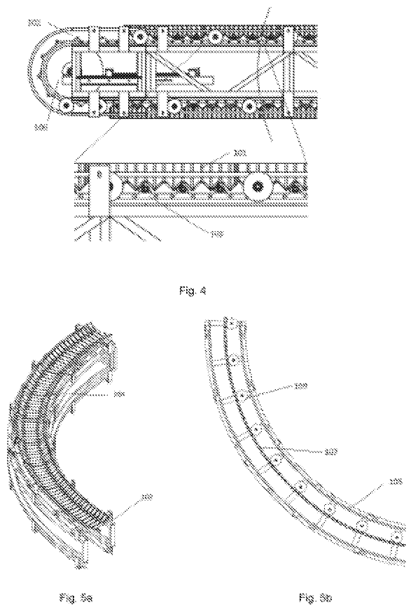

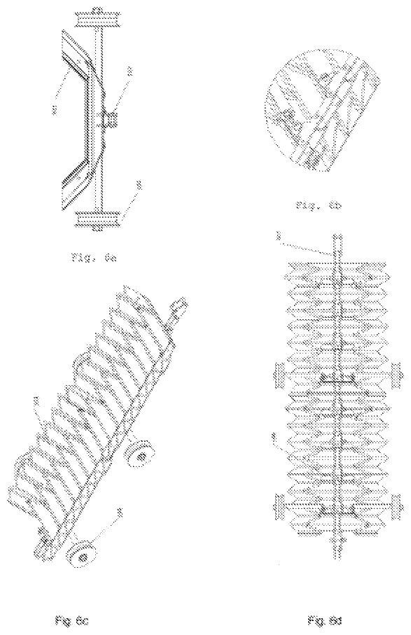

### DETAILED DESCRIPTION OF THE INVENTION

Although the present application may be susceptible to different embodiments, it is shown in the drawings and in the following detailed discussion, a preferred embodiment with the understanding that the present description should be considered an example of the principles of the invention and is not intended to limit the present invention to what has been illustrated and described here.

The object of the present invention consists of a flexible conveyor belt assembly 100 for moving products and/or raw materials in bulk, which comprises a support structure extending in a straight or curved manner 105, to which are fixed the rails 102, a toothed actuating wheel 103 and the toothed return wheel 106, and additionally comprises deflection wheels 109, an flexible conveyor belt 101 made of elastomeric material, particularly rubber, in a pleated profile, made with metallic inserts 108, a traction chain 107 and movable pulleys 104 that move along the structure, wherein the traction is exerted on the chain 107. The chain 107 is attached to the flexible rubber belt 101 through the metallic inserts (108) and screws.

Since traction of the system is made by means of the chain, the actuation is carried out by means of toothed actuating wheels 103.

As traction is exerted on chain 107, at no time the flexible conveyor belt 101 is pulled (stretched), thus, contributing to increase the life cycle of the flexible rubber conveyor belt 101. Therefore, the function of the flexible conveyor belt 101 is exclusively to receive and transport the material.

The flexible conveyor belt 101 is supported on a metallic support structure 105, with relative movement to this structure 105. The movement of the flexible conveyor belt 101 is driven by a gearmotor (not shown) coupled to the toothed actuating wheel 103. The toothed actuating wheel 103 is responsible for converting the rotary movement to the motor, in linear movement of the belt.

The actuation made by toothed wheel is cheaper and lighter because it is leaner than the actuation drum. As the toothed wheel actuates only in the middle of the equipment, the actuation shaft is shorter, causing less vibration in the equipment. Toothed wheel and chain actuations are known for their robustness and zero slip due to toothed gearing.

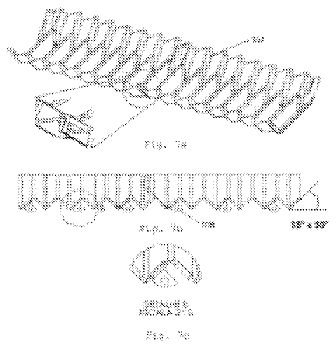

The flexible conveyor belt 101 is designed with a pleated profile at an angle ranging from 35 to 55°, preferably 45° (FIG. 7), and with metallic inserts 108 in the structure of the flexible rubber conveyor belt 101 so that it can deform only elastically in the curves, wherein the flexible rubber conveyor belt 101 has the capacity of elastic deformation in any direction, thus, making it possible to follow short radius curves in the horizontal plane.

This profile includes both the center and the side of the belt, allowing for deformation evenly. All the tractive effort is carried out on the chain 107 which is connected to the flexible conveyor belt 101. The flexible conveyor belt 101 moves along the equipment by pulleys 104 fixed to the belt by means of screws, the flexible rubber conveyor belt 101 and the pulleys 104 run on double rails 102 along the length of the flexible conveyor belt assembly 100, in which the transverse axis connected with the pulleys at the ends provides greater stability and robustness for the equipment and uniformity in the movement of the assembly.

The rails 102 comprise the full extension of the flexible conveyor belt assembly 100. There are two pairs of rails 102, one on the right side and one on the left side. In each pair of rails 102, each rail has a specific function. The lower rail 102 (FIGS. 2 and 4) has the function of supporting the weight of the flexible conveyor belt 101, load and pulleys 104. The function of the upper rail 102 is to keep the pulleys 104 aligned. Double rails 102 are used so that the flexible conveyor belt 101 can turn when passing through the ends of the equipment and so that horizontal curves can be made.

The shaft with the pulleys 104 at the end is fixed in a rigid element, the chain 107, avoiding traction problems of the shaft during the operation of the equipment.

When the pulleys are attached to an elastic element, such as a rubber belt, if a pulley is stuck, there is a great risk of loosening and causing the belt to tear.

The tensions (efforts) in the horizontal curves are supported by means of deflection wheels 109 and partially through the double rails.

The deflection wheels 109 or sliding guides are responsible for receiving a large part of the force components in the horizontal curves, thus preventing the warping of the double rails. In addition, the movement in the curve becomes more uniform and less abrupt. The deflection wheels 109 receive the loads due to the tensioning of the traction chain.

The flexible rubber conveyor belt modules 101 are made with metallic inserts 108 in their structure, inside the belt, in overlapping mounting. The metallic inserts 108 are plates that are vulcanized together with the rubber modules. These metallic inserts 108 are used for fastening with the chain 107. A major advantage of the flexible conveyor belt assembly 101 of the present invention is that instead of using rotary rollers fixed along the support structure 105, mobile pulleys 104 are used fixed to the flexible rubber conveyor belt 101. The support structure 105 is designed in metallic structure and receives the reinforcements and fixation of the other components.

The tension or slack adjustment of the chain 107 is done through a stretch system. The stretch system allows the adjust of the chain tension 107 for an ideal working condition and for when there is a gap in the chain 107 due to component wear.

As described above, one of the great advantages of the present invention is that a single conveyor belt is capable of carrying out the same work as two or more interconnected conventional conveyor belts. An equipment that can perform the same function as two or more equipment connected in series, has a greater operational availability as a whole. In series systems, the total availability is equal to the multiplication of the partial availability of each equipment. Therefore, when a conveyor belt can do the same job as two or more interconnected belts, the total availability increases.

Furthermore, as it is a single equipment, the number of motors, electric starter systems, actuators, transfer chutes and components are reduced, and the length can be about 15% less.

The total energy consumption considering a single flexible conveyor belt replacing the association of belts is less due to two factors, the total length of the conveyor is shorter and the energy expenditure to raise the material so that it is transferred to another conveyor belt is not necessary. This energy expenditure is quite significant, because depending on the length of the equipment, the energy required for vertical displacement is much more relevant than for horizontal transport.

Chain traction makes the equipment more robust and reliable. The chain is pulled by toothed wheels that are cheaper and more reliable than drums, as they often need to change the lining.

The belt is divided into modules, making maintenance faster. Any belt tear that occurs in a module, the screws that connect this module are removed, and it is replaced with a new module. This avoids the long time for amendment/vulcanization of current belts.

As it has the capacity to follow curves with short radii, the flexible conveyor belt of the invention allows to optimize spaces using them in the best way to make the plants lean. In many cases, the beneficiation plants are stretched because it is necessary to gain height with the belt conveyors. Using this new equipment concept, plant layouts can be optimized.

Due to the different design of the belt, it is possible to operate on slopes higher than usual under certain operating conditions. Normally for some types of ores, the maximum inclination adopted in conventional conveyor belts is around 18°. For the flexible conveyor belt of the present invention, this inclination could be greater, around 45°.

The flexible design of the flexible conveyor belt allows it to adapt to the layout of existing installations.

When using double rails, the pulleys remain constantly aligned. This avoids one of the main reasons that causes loss of production due to problems in the conveyor belts, that is, belt misalignment.

As it is a unique equipment, there are no intermediate transfers of the material transported along the route. Transfer points are places that require periodic maintenance due to the abrasion of the transported material.

Although only one embodiment of the present invention has been shown, it will be understood that various omissions, substitutions and changes can be made by a technician skilled in the subject-matter, without departing from the spirit and scope of the present invention. The described embodiments should be considered in all aspects only as illustrative and not restrictive.

It is expressly provided that all combinations of elements that perform the same function in substantially the same way to achieve the same results are within the scope of the invention. Replacements of elements from one described embodiment to another are also fully intended and contemplated.

It is also necessary to understand that the drawings are not necessarily in scale, but that they are only of a conceptual nature. The intention is therefore to be limited, as indicated by the scope of the appended claims.

We claim:

1. Flexible conveyor belt assembly (100) with a chain traction system for moving products/raw materials in bulk, which comprises a support structure extending in a straight or curved manner (105), to which are fixed the rails (102), the toothed actuating wheel (103) and the toothed return wheel (106), characterized in that it additionally comprises deflection wheels (109), a flexible rubber conveyor belt (101), with a pleated profile, produced with metallic inserts (108), a chain (107) and pulleys (104) that move along the structure, in which traction is exerted on the chain (107).

2. Flexible conveyor belt assembly (100) of claim 1, characterized in that the chain (107) is attached to the flexible rubber conveyor belt (101) through the metallic inserts (108) and screws.

3. Flexible conveyor belt assembly (100) of claim 1, characterized in that the drive is carried out by means of the toothed actuating wheel (103).

4. Flexible conveyor belt assembly (100) of claim 1, characterized in that the flexible rubber conveyor belt (101) is designed with a pleated profile at an angle ranging from 35 to 55°, wherein the metallic inserts in the belt structure are connected with the pulleys (104) and the chain (107).

5. Flexible conveyor belt assembly (100) of claim 4, characterized in that the flexible rubber conveyor belt (101) is designed with a pleated profile at an angle of 45°.

6. Flexible conveyor belt assembly (100) of claim 1, characterized in that the flexible rubber conveyor belt (101) moves along the equipment by pulleys (104) attached to the belt by means of screws, wherein the flexible rubber conveyor belt (101) and the pulleys (104) run on double rails (102) along the length of the flexible conveyor belt assembly (100).

7. Flexible conveyor belt assembly (100) of claim 6, characterized in that the double rails (102) comprise the total length of the flexible conveyor belt assembly (100).

8. Flexible conveyor belt assembly (100) of claim 1, characterized in that the chain tensions (107) in the horizontal curves are supported by the deflection wheels (109).

9. Flexible conveyor belt assembly (100) of claim 1, characterized in that the rubber flexible conveyor belt modules (101) are made with metal inserts (108) in their structure, inside the belt, in overlapped assembly.
